(19) United States
(12) Patent Application Publication
(10) Pub. No.: US 2026/0064339 A1
(43) Pub. Date: Mar. 5, 2026

(54) STORAGE MEDIUM, INFORMATION PROCESSING APPARATUS, AND INFORMATION PROCESSING METHOD

(71) Applicant: CANON KABUSHIKI KAISHA, Tokyo (JP)

(72) Inventor: MARIKO GENDA, Kanagawa (JP)

(21) Appl. No.: 19/285,432

(22) Filed: Jul. 30, 2025

(30) Foreign Application Priority Data
Aug. 30, 2024 (JP) 2024-150053

(51) Int. Cl. G06F 3/12

(52) U.S. Cl. CPC G06F 3/1257; G06F 3/1205

(57) ABSTRACT

A storage medium storing a program which causes a computer to function as: a notification unit to notify application software of information on a plurality of candidates including a specific candidate; an obtaining unit to obtain a print instruction from the application software; and a control unit to control so that, as the obtaining unit obtains a print instruction indicating that a setting corresponding to the specific candidate is selected for the first setting item, printing is performed by setting values for the first setting item and a second setting item related to printing different from the first setting item to values corresponding to the specific candidate.

### BACKGROUND

### Field of the Technology

The present disclosure relates to print control for sending print data.

### Description of the Related Art

A method is known for saving print setting selected by a user.

Japanese Patent Laid-Open No. 2005-339217 describes saving a combination of sheet size and sheet type selected by a user, and displaying the saved combination of sheet size and sheet type on a sheet selection screen for the user to make a selection.

### SUMMARY

A storage medium according to the present disclosure stores a program which causes a computer to function as: a notification unit configured to notify application software capable of receiving an instruction to print displayed contents of information on a plurality of candidates including a specific candidate as a candidate that can be set for a first setting item related to printing; an obtaining unit configured to obtain a print instruction including content set for the first setting item from the application software; and a control unit configured to control so that, as the obtaining unit obtains a print instruction indicating that a setting corresponding to the specific candidate is selected for the first setting item, printing is performed by setting values for the first setting item and a second setting item related to printing different from the first setting item to values corresponding to the specific candidate.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing a configuration example of a print system;

FIG. 2 is a block diagram showing an example of a function framework of a PC;

FIGS. 3A and 3B are diagrams showing an example of a print instruction screen provided by an application;

FIGS. 4A and 4B are diagrams showing an example of a print setting screen provided by a printer driver;

FIG. 5 is a flowchart of print setting processing;

FIG. 6 is a flowchart of a driver capability information generation process;

FIG. 7 is a diagram showing an example of a custom setting list;

FIG. 8 is a flowchart of a custom setting saving process;

FIG. 9 is a diagram showing an example of a custom setting save screen;

FIG. 10 is a flowchart of a custom setting name generation process;

FIG. 11 is a flowchart of print instruction processing;

FIG. 12 is a flowchart of print processing;

FIGS. 13A and 13B are diagrams showing an example of print setting information;

FIG. 14 is a diagram showing an example of a custom setting edit screen;

FIG. 15 is a diagram showing an example of a print setting screen provided by a printer driver;

FIG. 16 is a flowchart of print setting processing;

FIG. 17 is a flowchart of a favorites setting saving process;

FIG. 18 is a diagram showing an example of a favorites save screen;

FIG. 19 is a diagram showing an example of a custom setting list; and

FIG. 20 is a flowchart of print processing.

### DESCRIPTION OF THE EMBODIMENTS

Embodiments of the technology of the present disclosure will be described below. The following embodiments are not intended to limit the technology of the present disclosure according to the claims, and not all combinations of features described in the following embodiments are necessarily essential to the solution of the technology of the present disclosure.

### Embodiment 1

In a case where a user sets up print settings, the print settings are set up via a print setting screen provided by an application or a print setting screen provided by a printer driver that is displayed upon start-up of the application.

It is conceivable to save the print settings selected by the user in the print setting screen provided by the application as custom settings. However, settings set up in the application cannot be shared with other applications. On the other hand, the print setting screen provided by the printer driver can be started from any application. Therefore, if the print settings from the print setting screen provided by the printer driver are saved as the custom settings, the custom settings can be used from any application. However, in this case, the user needs to start the print setting screen of the printer driver from the application every time the user is going to use the custom settings, which is troublesome for the user.

It is an object of the present embodiment to enable the user to instruct printing with pre-saved custom settings without starting the print setting screen of the printer driver. Therefore, in the present embodiment, a method will be described in which the user can select the pre-saved custom settings from the print setting screen that is displayed in a case of giving a print instruction from the application.

### [Configuration Example of Print System]

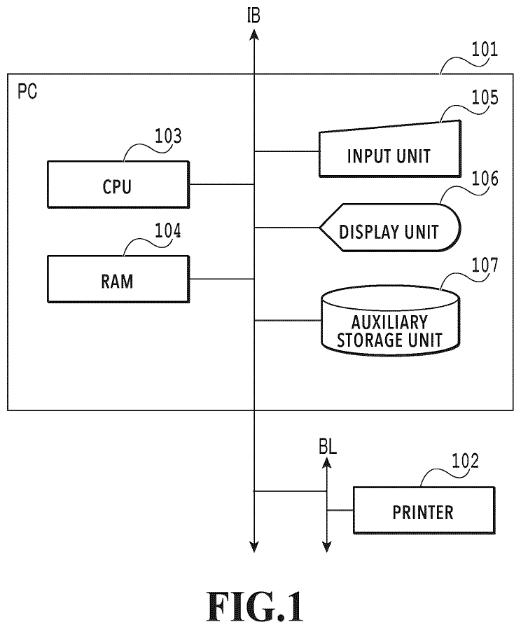

FIG. 1 is a diagram showing a configuration example of a print system, which is an information processing system according to the present embodiment. The print system includes a printer 102 and a PC 101 as an information processing apparatus connected to the printer 102.

The PC 101 includes a CPU 103 as a central processing unit, a RAM 104 as a storage unit, an input unit 105, a display unit 106, and an auxiliary storage unit 107. The respective units included in the PC 101 are connected by an internal bus line IB.

The display unit 106 is a CRT, LCD or the like, and displays a screen provided by an application, a print setting screen provided by a printer driver, and the like. The input unit 105 is composed of a mouse, a keyboard, and the like, and receives various inputs made by a user to the screen displayed on the display unit 106. The CPU 103 operates as a display control unit to control the display of the screen by the display unit 106, and an operation control unit to control the input unit 105.

The auxiliary storage unit 107 is a ROM, a hard disk, an SSD, or the like. The auxiliary storage unit 107 stores a group of programs of application software 201 (hereinafter referred to as the application 201) and an operating system (hereinafter referred to as OS). The auxiliary storage unit 107 also stores printer driver software 210 (hereinafter referred to as the printer driver 210) and various other data. The internal bus line IB of the PC 101 is connected to the printer 102 by an external bus line BL, and the PC 101 can register jobs with the printer 102.

### [Function Framework of Printer Driver]

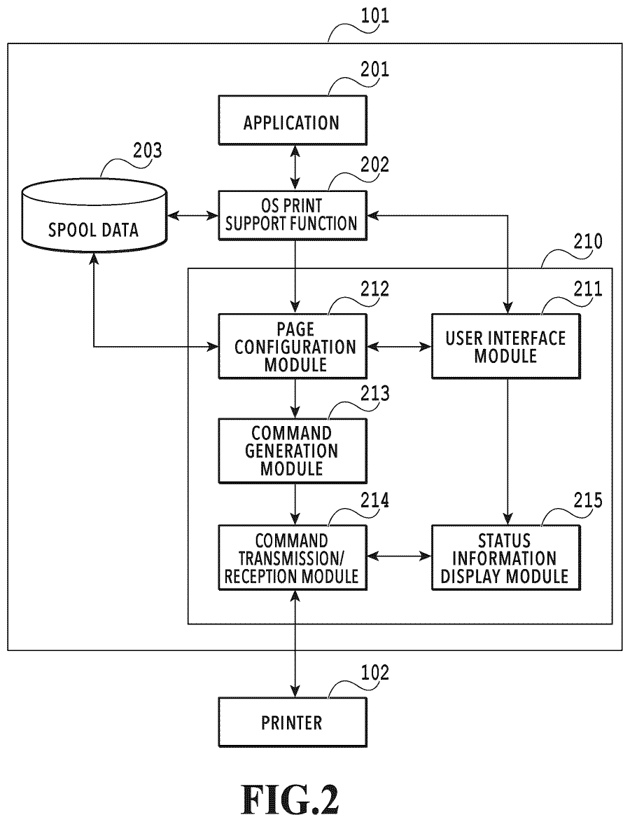

FIG. 2 is a block diagram showing an example of a function framework of the printer driver 210 installed in the PC 101 and compatible with the printer 102. The printer driver 210 according to the present embodiment includes a user interface module 211, a page configuration module 212, a command generation module 213, a command transmission/reception module 214, and a status information display module 215.

Upon receipt of an instruction to display a print setting screen from the application 201, the user interface module 211 displays the print setting screen on the display unit 106 to provide a unit for the user to confirm and change the print settings.

As the user issues a print instruction from a print setting screen to be described later, the user interface module 211 returns print setting information indicating the contents set via the print setting screen to the application 201 via an OS print support function 202. The print setting information is information indicating a setting value for each setting item related to printing. As for the setting item of “sheet size”, for example, the setting value “A4” is included in the print setting information.

The application 201 adds the print setting information returned from the user interface module 211 to print data. The print data created by the application 201 is temporarily stored as spool data in a print queue of a spooler 203 via the OS print support function 202. The spool data is managed by the spooler 203 as a print job with a name and the like added. Upon receipt of a notification to start printing from the OS print support function 202, the user interface module 211 starts the status information display module 215.

The print job is converted by the printer driver 210 into a print command that can be interpreted by the printer 102, and then supplied to the printer 102 for printing. Specifically, the print job passed to the printer driver 210 is first processed by the page configuration module 212. The page configuration module 212 performs page configuration processing on the print job, such as rearranging pages of the print job according to the print setting information and combining a plurality of pages into one page.

The print job is then processed by the command generation module 213. The command generation module 213 converts the print data included in the print job into print commands that can be interpreted by the printer 102 according to the print setting information.

The print commands are sequentially sent to the printer 102 by the command transmission/reception module 214. The command transmission/reception module 214 reads the status of the printer 102, such as information that an error has occurred in the printer 102 and information about the page currently being printed, and passes the status to the status information display module 215.

The status information display module 215 provides a unit for the user to check the status of a print job or the status of the printer 102. Specifically, the status information display module 215 analyzes the status of the printer 102 and displays information about the printer 102 as a status information display screen on the display unit 106.

Each module of the printer driver 210 shown in FIG. 2 is implemented by the CPU 103 reading a program of the printer driver 210 stored in the auxiliary storage unit 107 into the RAM 104 and executing the program.

In the present embodiment, the user interface module 211 and the status information display module 215 included in the printer driver 210 are described as performing the processing, but the print-related functions in the PC 101 are not limited to this configuration. For example, the functions of the user interface module 211 and the status information display module 215 may be included in the OS print support function 202. In this case, the processing performed by the user interface module 211 and the status information display module 215 described above may be performed by the OS print support function 202.

### [Print Setting Screen]

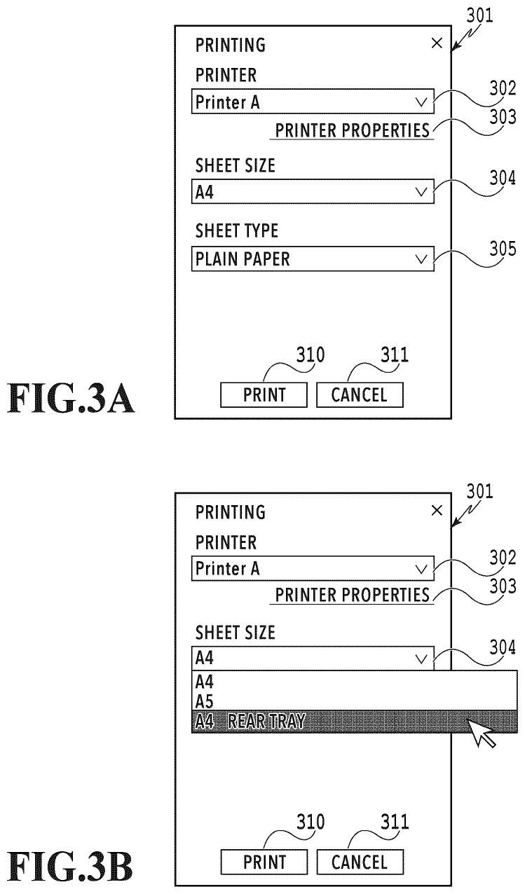

FIGS. 3A and 3B are diagrams showing examples of a print instruction screen 301, which is a print setting screen provided by the application 201. The print instruction screen 301 is a screen for receiving an instruction to print contents displayed by the application 201. As the user issues a print instruction from the application 201, the application 201 first displays the print instruction screen 301 shown in FIGS. 3A and 3B. The print instruction screen 301 of the application 201 includes a printer combo box 302, a sheet size combo box 304, and a sheet type combo box 305. The printer combo box 302 is a combo box for selecting a printer to be used. The sheet size combo box 304 and the sheet type combo box 305 are combo boxes for displaying candidates for the setting values of the print setting items and for changing the setting values.

The print settings include settings (called public settings) that are prepared by the OS and can be used by all vendors, and settings (called private settings) that are unique to each vendor. Typical setting items of the public settings include sheet size, sheet feeding method, sheet type, double-sided printing, and the number of copies. The sheet size combo box 304 and the sheet type combo box 305 are combo boxes corresponding to the setting items of the public settings. Not all setting items of the public settings can be selected from the print instruction screen 301. Depending on the application, there may be public setting items for which no combo box for a user to select a setting value is displayed in the print instruction screen 301 provided by the application.

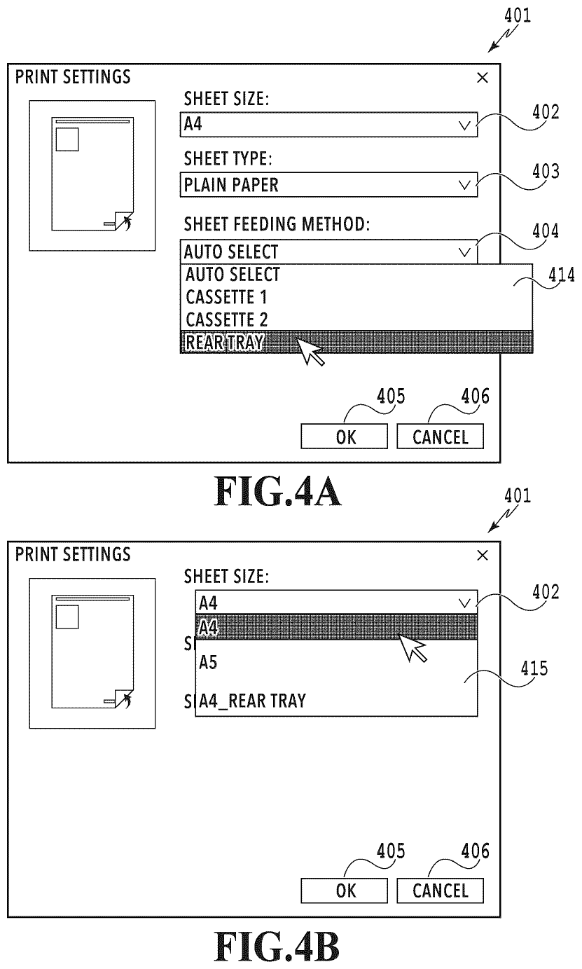

A print button 310 is a button for instructing printing to the printer selected in the printer combo box 302. The print instruction screen 301 of the application 201 also includes a link 303 for displaying a print setting screen 401 (see FIGS. 4A and 4B) of the printer driver 210.

FIGS. 4A and 4B show examples of the print setting screen 401 displayed by the user interface module 211 and provided by the printer driver 210. The print setting screen 401 allows settings to be set up for setting items that cannot be set in the print instruction screen 301 provided by the application 201.

### [Print Setting Processing]

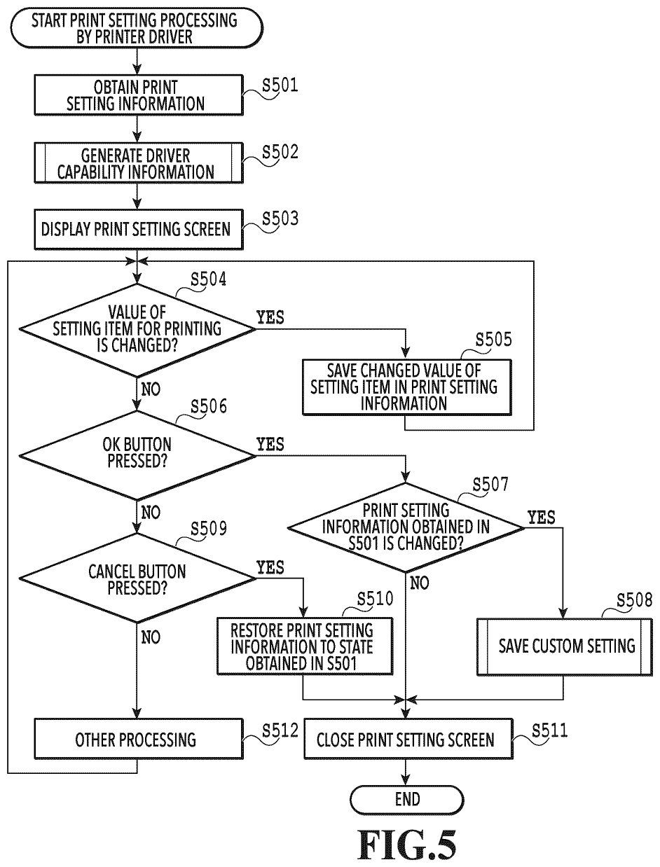

FIG. 5 is a flowchart for explaining the print setting processing by the printer driver 210. The print setting processing is started as an instruction to display the print setting screen is passed from the OS of the PC 101 or the application 201 of the PC 101 to the user interface module 211 via the OS print support function 202. Specifically, the flowchart of FIG. 5 is started as the user presses the link 303 for instructing the display of the print setting screen 401, in the print instruction screen 301 of the application 201.

The flowchart of FIG. 5 is performed as the processing by the printer driver 210. That is, the processing according to the flowchart of FIG. 5 is performed by expanding a program code of the printer driver 210 stored in the auxiliary storage unit 107 into the RAM 104 and executing the program code by the CPU 103. The symbol “S” in the description of each process means a step in the flowchart, and the same applies to subsequent flowcharts.

In S501, the CPU 103 functioning as the printer driver 210 obtains print setting information passed from the OS print support function 202. The CPU 103 saves the obtained print setting information in the auxiliary storage unit 107. The obtained print setting information is information indicating default values of print setting or the contents of the print setting changed in the print instruction screen 301 of the application 201 in FIGS. 3A and 3B.

In S502, the CPU 103 generates driver capability information for each print setting item.

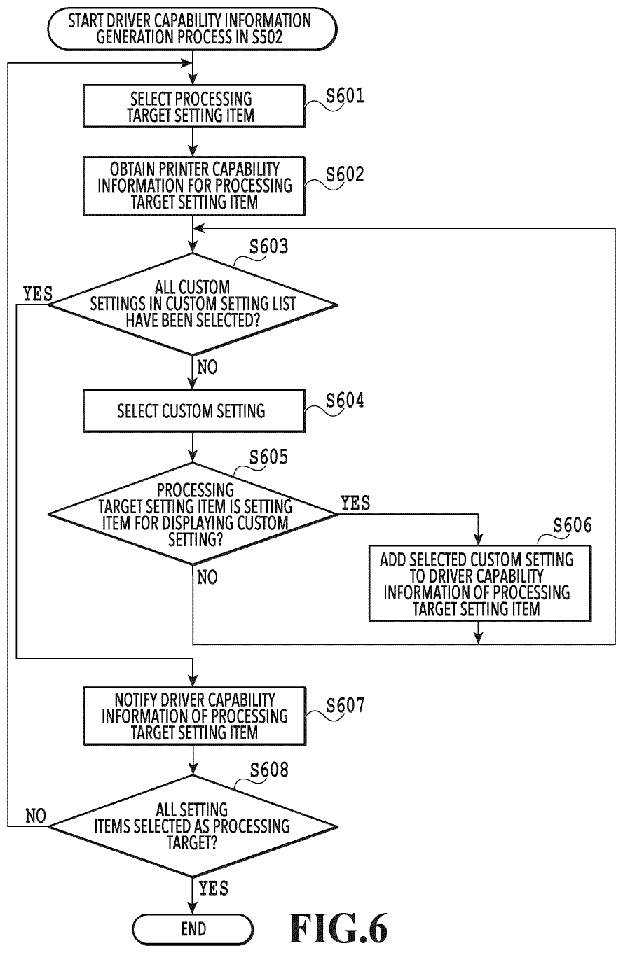

FIG. 6 is a flowchart for explaining a series of processing in a driver capability information generation process. The flowchart of FIG. 6 is performed as the processing by the printer driver 210. That is, the processing according to the flowchart of FIG. 6 is performed by expanding a program code of the printer driver 210 stored in the auxiliary storage unit 107 into the RAM 104 and executing the program code by the CPU 103.

The processing of S601 to S608 is loop processing. In S601, the CPU 103 selects a processing target setting item from among unselected setting items. The CPU 103 then executes the processing of S602 to S607 for the processing target setting item. If the CPU 103 judged in S608 that there is a setting item yet to be selected as the processing target (NO in S608), the CPU 103 returns to S601 to select a new processing target setting item from among the unselected setting items, and repeats the processing of S602 to S607. In the present embodiment, description will be given assuming that the print setting items are “sheet size”, “sheet type”, and “sheet feeding method”. Therefore, in S601, the processing target is selected from among “sheet size”, “sheet type”, and “sheet feeding method”.

In S602, the CPU 103 obtains printer capability information for the processing target setting item. The printer capability information is a list of values of setting items that can be used by the printer 102. For example, the printer 102 of the present embodiment supports sheet sizes A4 and A5. If the processing target setting item selected in S601 is “sheet size”, the CPU 103 obtains “A4” and “A5” as the printer capability information for the sheet size in S602. For the printer 102 of the present embodiment, the printer capability information for the sheet type is “plain paper” and “photo paper”. The printer capability information for the sheet feeding method is “auto select”, “cassette 1”, “cassette 2”, and “rear tray”.

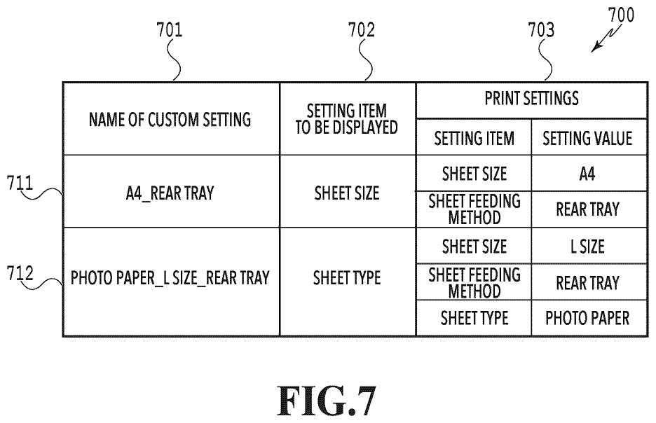

First, the flowchart of FIG. 6 will be described for a case where no custom settings are saved and a custom setting list 700 (see FIG. 7) to be described later is not saved. If no custom settings are saved, the CPU 103 judges in S603 that all custom settings are selected (YES in S603), and proceeds to S607 without performing the processing of S604 to S606. The processing of S604 to S606 will be described in detail later after the description of the custom setting list 700.

In S607, the CPU 103 outputs the driver capability information for the processing target setting item, which is generated by adding the custom setting obtained as a result of the loop processing of S603 to S606 to the printer capability information obtained in S602. The driver capability information is information on the candidates (such as A4 and A5) that can be set for that setting item (for example, sheet size).

If no custom settings are saved, the printer capability information obtained in S602 serves as the driver capability information. That is, if the processing target setting item is “sheet size”, “A4” and “A5” are outputted as the driver capability information in S607. If the processing target setting item is “sheet type”, “plain paper” and “photo paper” are outputted as the driver capability information. If the processing target setting item is “sheet feeding method”, “auto select”, “cassette 1”, “cassette 2”, and “rear tray” are outputted as the driver capability information.

The CPU 103 then proceeds to S608. If the CPU 103 judged that the driver capability information is outputted for all setting items (YES in S608), the CPU 103 ends the flowchart of FIG. 6 and then proceeds to S503 in FIG. 5.

In S503, the CPU 103 obtains the driver capability information for each setting item generated in S502, and displays the print setting screen 401 in FIGS. 4A and 4B.

As shown in FIGS. 4A and 4B, the print setting screen 401 of the printer driver 210 includes combo boxes 402 to 404 for displaying candidates for the setting values of the print setting items “sheet size”, “sheet type”, and “sheet feeding method”, respectively.

The CPU 103 functioning as the printer driver 210 displays the driver capability information generated in S502 in drop-down lists displayed as the user clicks on the combo boxes 402 to 404. For example, as the sheet size combo box 402 is pressed, “A4” and “A5” as the driver capability information for the sheet size are added as pull-down menu items (setting value candidates).

Similarly, the sheet type combo box 403 is set to display the driver capability information for the sheet type generated in S502. The sheet feeding method combo box 404 is set to display the driver capability information for the sheet feeding method generated in S502. Then, the print setting screen 401 is displayed in a state where the print setting information setting passed from the OS print support function 202 is selected.

Accordingly, as shown in FIG. 4A, the sheet feeding method combo box 404 displays the default value “auto select”. A drop-down list 414 displayed as the sheet feeding method combo box 404 is pressed displays the driver capability information options “auto select”, “cassette 1”, “cassette 2”, and “rear tray”.

In S504, the CPU 103 judges whether the setting value of any setting item is selected to change to another value by the user in the print setting screen 401. If the CPU 103 judged that the setting value is selected to change (YES in S504), the CPU 103 proceeds to S505. In S505, the CPU 103 changes the selected setting value among the print setting information obtained in S501 to the other value selected by the user in the print setting screen 401. Then, the CPU 103 returns to S504.

For example, it is assumed that the user has changed the setting value from “auto select” to “rear tray” via the sheet feeding method combo box 404 in the print setting screen 401 of FIGS. 4A and 4B. In this case, the CPU 103 judges in S504 that the print setting value has been selected to change, and changes the setting value of the sheet feeding method to “rear tray” in the print setting information in S505.

On the other hand, if the CPU 103 judged that the setting value has not been changed (NO in S504), the CPU 103 proceeds to S506. In S506, the CPU 103 determines whether an OK button 405 in the print setting screen 401 is pressed.

If the CPU 103 judged that the OK button 405 is pressed (YES in S506), the CPU 103 proceeds to S507, or otherwise (NO in S506) proceeds to S509. In S509, the CPU 103 judges whether a cancel button 406 in the print setting screen 401 is pressed. If the CPU 103 judged that the cancel button 406 is pressed (YES in S509), the CPU 103 proceeds to S510, or otherwise (NO in S509) proceeds to S512.

In S510, the CPU 103 restores the print setting information to the contents obtained in S501, and proceeds to S511. In S512, the CPU 103 performs processing according to the user's operation, and then returns to S504.

On the other hand, in S507, the CPU 103 judges whether the print setting information obtained in S501 is changed. If the CPU 103 judged that the print setting information obtained in S501 is changed (YES in S507), the CPU 103 proceeds to S508, or otherwise (NO in S507) proceeds to S511. In S508, the CPU 103 executes a custom setting saving process for presenting and saving the custom setting.

### [Custom Setting]

FIG. 7 is a diagram showing an example of a custom setting list for managing the custom setting saved as a result of the processing in S508. In the present embodiment, setting values of two or more setting items (a first setting item and a second setting item) are saved as one custom setting. For example, the first setting item can be selected and set from among a plurality of candidates in the print instruction screen 301 provided by the application 201. The second setting item cannot be set in the print instruction screen 301 provided by the application 201. As the user selects a certain custom setting, the print setting information is automatically updated to the setting values of two or more setting items corresponding to the selected custom setting.

The custom setting list 700 has a row provided for each custom setting. In each row, a column 701 has the name of each custom setting is held in, a column 702 has the setting item displayed as the custom setting candidate, and a column 703 has the print setting saved as a custom setting. In the print setting in the column 703, the setting items are associated with the setting values corresponding to the setting items, respectively.

The “displayed setting item” held in the column 702 indicates the setting item (first setting item) for which the custom setting is displayed as a candidate in the print instruction screen 301 and the print setting screen 401. For example, “sheet size” is held in a row 711 as the setting item for which the custom setting is displayed. Therefore, in a case where the printer driver 210 generates driver capability information, the driver capability information for the sheet size includes the custom setting “A4_rear tray” held in the row 711. Therefore, the user can select the custom setting “A4_rear tray” from among the setting value candidates displayed as the sheet size combo box 304 in the print instruction screen 301 or the sheet size combo box 402 in the print setting screen 401 is pressed. Accordingly, the custom setting is displayed as one of the setting value candidates for the first setting item, and thus the custom setting is sometimes referred to as a “specific candidate”.

If the custom setting is selected, the print setting information is changed to the value held in “print setting” in the custom setting list 700. For example, if the custom setting “A4_rear tray” is selected, “A4” is obtained as the setting value of “sheet size” held in “print setting” in the row 711 of the custom setting list 700, and “rear tray” is obtained as the setting value of “sheet feeding method”. Then, the print setting information is updated with the obtained setting values. Therefore, if one custom setting is selected, two or more setting items can be set.

In the present embodiment, if the print setting is changed from the default in the print setting screen 401 provided by the printer driver 210, the processing transitions to S508. In S508, processing is performed to automatically display the custom setting based on the setting value of the changed setting item and to prompt the user to save the displayed custom setting.

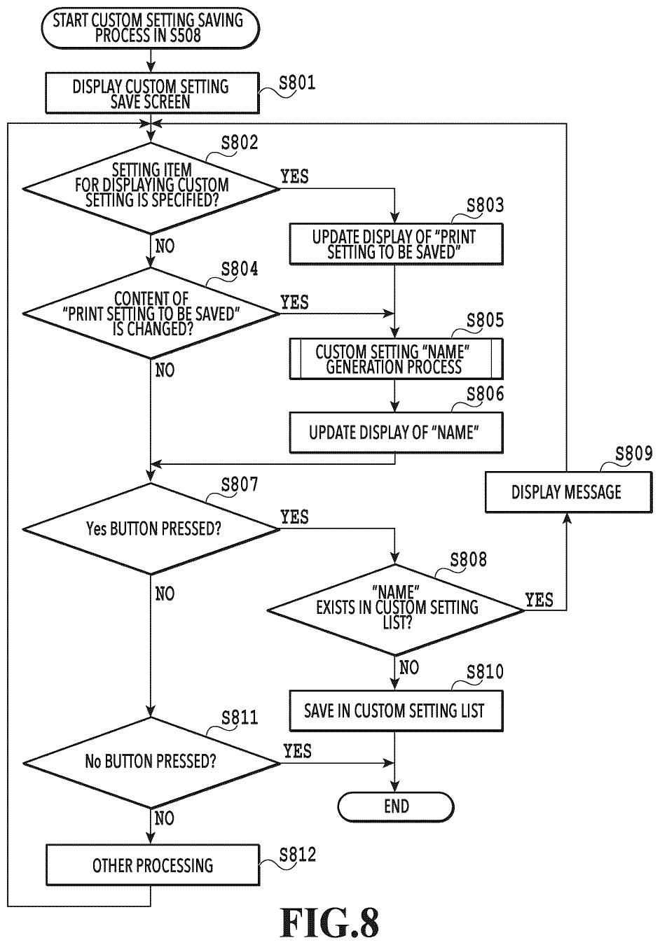

FIG. 8 is a flowchart for explaining the details of the custom setting saving process executed in S508. The flowchart of FIG. 8 is executed as the processing by the printer driver 210. That is, the processing according to the flowchart of FIG. 8 is performed by expanding a program code of the printer driver 210 stored in the auxiliary storage unit 107 into the RAM 104 and executing the program code by the CPU 103.

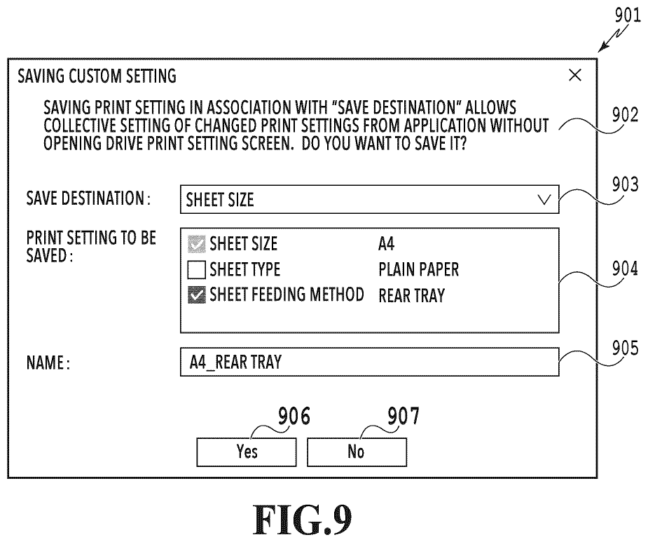

In S801, the CPU 103 functioning as the printer driver 210 displays a custom setting save screen 901 (see FIG. 9).

FIG. 9 is a diagram showing an example of the custom setting save screen 901. The custom setting save screen 901 includes a message 902, a save destination combo box 903, a print setting list box 904, a name edit box 905, and the like.

The message 902 is a text to prompt the user to save the custom settings displayed on the custom setting save screen 901.

The save destination combo box 903 is a combo box for the user to select a setting item (first setting item) for displaying the custom setting if the displayed custom setting is saved. In other words, the save destination combo box 903 is a combo box for selecting a setting item of which driver capability information the custom setting which is displayed on the custom setting save screen 901, is added to. The user can select a setting item for displaying the custom setting from a pull-down list displayed by pressing the save destination combo box 903 is pressed.

The pull-down list displayed by pressing the save destination combo box 903 displays, for example, setting items whose setting values can be set from the print instruction screen 301 provided by the application 201, among the public items that are the OS standard print settings. Therefore, in the present embodiment, the user can select a setting item (first setting item) for displaying the custom setting from among the plurality of setting items, “sheet size” and “sheet type”.

The print setting list box 904 is a region for displaying a list of setting items and their setting values to be saved as print settings in the column 703 in the custom setting list 700. In the present embodiment, if the setting value of a default setting item is changed in the print setting screen 401, the custom setting save screen 901 displays a custom setting for setting up the print setting with the changed setting value. The default value is assumed to be a factory default setting.

The print setting list box 904 displays both the setting item (first setting item) selected from the save destination combo box 903 and its current setting value, and the setting items (second setting items) that can be set in the print setting screen 401 and their current setting values. As described above, the print setting screen 401 also makes it possible to set the setting item that cannot be set in the print instruction screen 301 provided by the application 201. Therefore, the setting items (second setting items) included in the print setting list box 904 include, for example, the setting items that cannot be set in the print instruction screen 301 provided by the application 201.

The current setting value is the setting value selected at the time of pressing the OK button 405 by the user in the print setting screen 401. In the print setting list box 904, a light gray setting item represent the setting item selected in the save destination combo box 903.

The print setting list box 904 is provided with check boxes. The printer driver 210 saves only the setting items and their setting values that correspond to check boxes checked in the print setting list box 904, in the print settings of the column 703 in the custom setting list 700. The user may be allowed to further customize the custom settings presented by the printer driver 210, or the print setting list box 904 may be displayed only so that the user can check the contents displayed as the custom setting list 700.

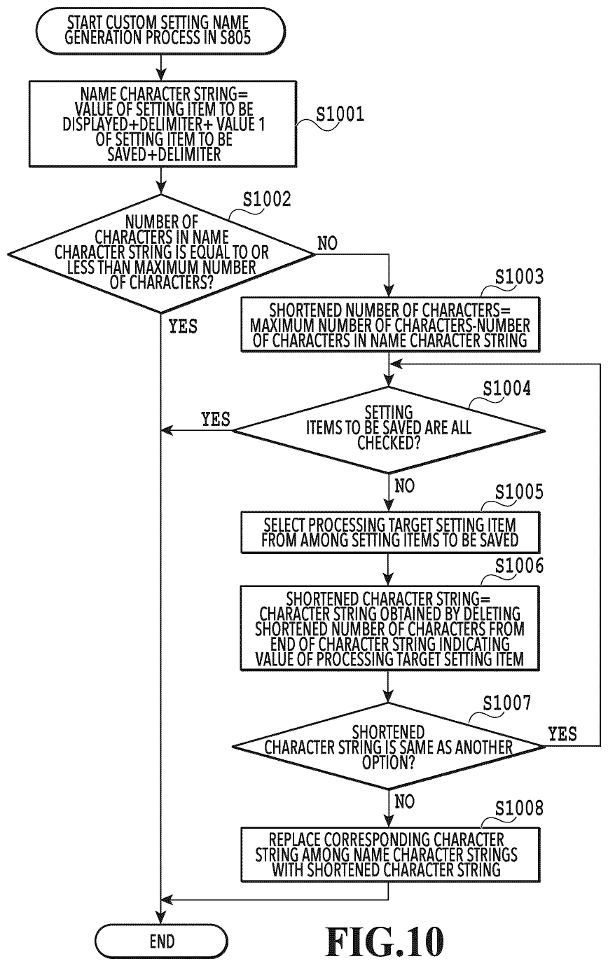

The name edit box 905 is a region for displaying a text that is generated in a flowchart of FIG. 10 to be described later, and is held in the column 701 as the name of the custom setting in the custom setting list 700. Referring back to FIG. 8, the description of the flowchart will be continued.

In S802, the CPU 103 judges whether a setting item is specified from the save destination combo box 903 in the custom setting save screen 901. If the CPU 103 judged that a setting item that is to be a display destination of the custom setting is specified (YES in S802), the CPU 103 proceeds to S803, or otherwise (NO in S802) proceeds to S804. In S803, the CPU 103 updates the items displayed in the print setting list box 904, and proceeds to S805.

On the other hand, the CPU 103 judges in S804 whether a check box in the print setting list box 904 in the custom setting save screen 901 is pressed to change the setting. If the CPU 103 judged that the setting in the print setting list box 904 is changed (YES in S804), the CPU 103 proceeds to S805.

In S805, the CPU 103 functioning as the printer driver 210 performs processing of generating a name of the custom setting.

FIG. 10 is a flowchart for explaining the processing of generating the name of the custom setting. The processing of this flowchart is executed as the processing by the printer driver 210. That is, the processing according to the flowchart of FIG. 10 is performed by expanding a program code of the printer driver 210 stored in the auxiliary storage unit 107 into the RAM 104 and executing the program code by the CPU 103.

In S1001, the CPU 103 functioning as the printer driver 210 generates a name character string to be a candidate for the name of the custom setting. The CPU 103 generates the name character string by combining texts indicating the setting values corresponding to the setting items checked in the print setting list box 904. The name character string begins with a character string indicating the setting value of the setting item selected in the save destination combo box 903, followed by a delimiter and a character string indicating the setting value to be saved, which are repeated for each setting item checked in the print setting list box 904. The delimiter is assumed to be “_”.

In the case of the print setting list box 904 shown in FIG. 9, since “sheet size” is selected in the save destination combo box 903, the first character string is “A4”, which is the setting value of “sheet size”. The first character string is followed by “rear tray” that is the setting value of “sheet feeding method”, thus obtaining a name character string “A4_rear tray”.

In S1002, the CPU 103 judges whether the name character string generated in S1001 is equal to or less than the maximum number of characters for the name of the custom setting. If the CPU 103 judged that the name character string is equal to or less than the maximum number of characters (YES in S1002), the CPU 103 determines that the name character string is the character string of the “name” of the custom setting and ends the flowchart of FIG. 10, or otherwise (NO in S1002), proceeds to S1003.

In S1003, the CPU 103 calculates a shortened number of characters. The shortened number of characters is obtained by subtracting the number of characters in the name character string determined in S1001 from the maximum number of characters.

The following S1004 to S1007 are loop processing. In S1005, the CPU 103 selects a processing target setting item, other than the setting item selected in the save destination combo box 903, from among the setting items checked in the print setting list box 904. The CPU 103 then executes the processing of S1006 to S1007 for the processing target setting item, and returns to S1004. If the CPU 103 judged in S1004 that there is a setting item yet to be selected as the processing target (NO in S1004), the CPU 103 proceeds again to S1005. In the next S1005, a new processing target setting item is selected from among the unselected setting items, and the processing of S1006 to S1007 is repeated.

In S1006, the CPU 103 deletes the shortened number of characters from the end of each character string indicating the setting value set for the processing target setting item to generate a shortened character string.

In S1007, the CPU 103 judges whether the shortened character string overlaps with other candidates for the processing target setting item. If the CPU 103 judged that the shortened character string overlaps with the other candidates (YES in S1007), the CPU 103 returns to S1004, or otherwise (NO in S1007), proceeds to S1008. In S1008, the CPU 103 determines that the character string obtained by replacing the character string corresponding to the shortened character string among the name character strings generated in S1001 with the shortened character string is the character string of the name of the custom setting, and then ends the flowchart of FIG. 10.

For example, it is assumed that the setting item selected from the save destination combo box 903 is the sheet size. It is also assumed that the setting value of the sheet size is “A4”, the setting value of the sheet type is “photo paper”, and the setting value of the sheet feeding method is “cassette 1”. In this case, the name character string generated in S1001 is “A4_photo paper cassette 1”. It is also assumed that the shortened number of characters is 2. If the sheet feeding method is selected as the processing target setting item in S1005, then in S1006, “cassette” is determined as the shortened character string by deleting two characters from “cassette 1”, which is the setting value of the processing target setting item. In S1007, it is determined whether the shortened character string “cassette” overlaps with “auto select”, “cassette 2”, and “rear tray”, which are other setting value candidates of the processing target setting item “sheet feeding method”. If the shortened character string is “cassette”, then it is determined that the shortened character string overlaps because it is a part of “cassette 2”. If the sheet type is selected as the processing target setting item in the next S1005, then in S1006, “photo” obtained by deleting two characters from “photo paper” that is the setting value of the sheet type is determined as the shortened character string. In S1007, it is determined whether the shortened character string “photo” overlaps with “plain paper”, which is another setting value candidate for the processing target setting item “sheet type”. Since it is determined that the shortened character string “photo” does not overlap with “plain paper” (NO in S1007), the processing proceeds to S1008. In S1008, the name character string is updated to “A4_photo_cassette 1” using the current shortened character string “photo”.

Accordingly, it is possible to automatically generate a name that avoids a situation where deleting the last character makes the name indistinguishable from other options. In the flowchart of FIG. 10, the character string is deleted from the setting value of one setting item, but may be deleted evenly from the setting values of a plurality of setting items.

On the other hand, if the CPU 103 judges that there is no setting item yet to be selected as the processing target (YES in S1004), it means that the name character string could not be shortened. In this case, the flowchart of FIG. 10 also ends. When the flowchart of FIG. 10 ends, the processing proceeds to S806 in the flowchart of FIG. 8.

In S806 of FIG. 8, the CPU 103 updates the character string displayed in the name edit box 905 to the character string generated in S805. The CPU 103 then proceeds to S807.

If the result of judgement in S1004 is YES and the processing transitions to S806, the name edit box 905 displays in S806 the name character string that exceeds the maximum number of characters. In this case, the CPU 103 makes it impossible for the user to save the custom setting unless the character string is shortened.

In S807, the CPU 103 judges whether a Yes button 906 in the custom setting save screen 901 is pressed. If the CPU 103 judged that the Yes button 906 is pressed (YES in S807), the CPU 103 proceeds to S808, or otherwise (NO in S807), proceeds to S811. It is assumed that in S802, the custom setting save screen 901 is displayed with no setting item selected in the save destination combo box 903. Therefore, even if a setting item for which the custom setting is displayed is not specified in the save destination combo box 903, the CPU 103 proceeds to S811 without receiving the pressing of the Yes button 906.

In S811, the CPU 103 judges whether a No button 907 in the custom setting save screen 901 is pressed. If the CPU 103 judged that the No button 907 in the custom setting save screen 901 is pressed (YES in S811), the CPU 103 ends the custom setting save process without saving the custom setting, or otherwise (NO in S811), proceeds to S812. In S812, the CPU 103 executes other processing and returns to S802.

On the other hand, in S808, the CPU 103 judges whether the character string displayed in the name edit box 905 exists as the name of the custom setting in the custom setting list 700 of FIG. 7. If the CPU 103 judged that the character string displayed in the name edit box 905 exists as the name of the custom setting (YES in S808), the CPU 103 proceeds to S809, or otherwise (NO in S808), proceeds to S810. In S809, the CPU 103 displays a message to the user that the name of the custom setting with the same name already exists, and returns to S802.

On the other hand, in S810, the CPU 103 saves the custom setting of the contents displayed in the custom setting save screen 901. That is, the CPU 103 adds a row to the custom setting list 700, and stores the character string displayed in the name edit box 905 as the name of the custom setting in the column 701 of the added row. The column 702 holds the setting items displayed in the save destination combo box 903 as the setting item to be displayed. The column 703 holds the setting item checked in the print setting list box 904 and its setting value as the print setting. The CPU 103 then ends the custom setting save process, which is the processing of the flowchart in FIG. 8.

Upon completion of the custom setting save process, the CPU 103 closes the custom setting save screen 901 and proceeds to S511 in the flowchart of FIG. 5. In S511 of FIG. 5, the CPU 103 closes the print setting screen 401 and ends the print setting processing by the printer driver 210.

[Selecting Custom Setting from Print Instruction Screen of Application]

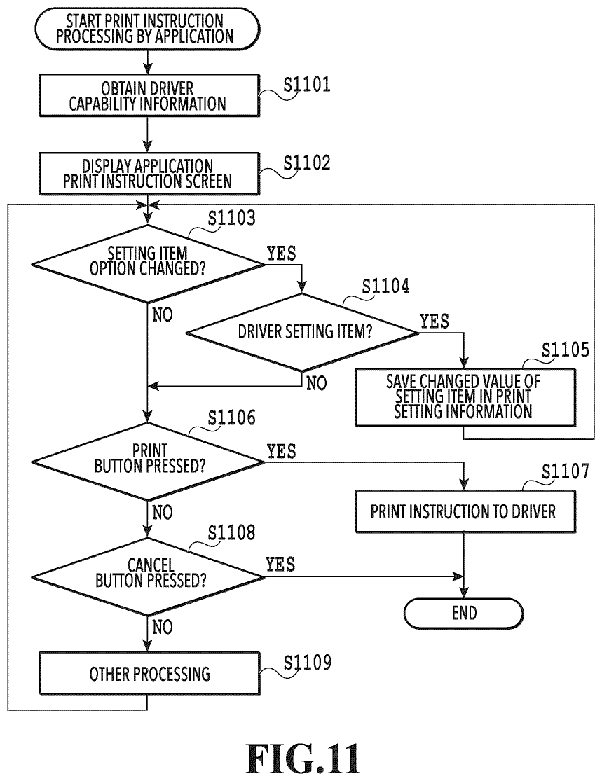

FIG. 11 is a flowchart for explaining print instruction processing by the application 201. That is, the processing according to the flowchart of FIG. 11 is performed by expanding a program code of the printer driver 210 or the OS stored in the auxiliary storage unit 107 into the RAM 104 and executing the program code by the CPU 103. In the present embodiment, the print instruction processing is described as being performed by the application 201, but may also be performed by the OS print support function 202.

Upon detection of an instruction to display the print instruction screen 301, the CPU 103 functioning as the application 201 starts the flowchart of FIG. 11.

In S1101, the CPU 103 functioning as the application 201 obtains driver capability information of a printer selected in the printer combo box 302 in the print instruction screen 301 of FIGS. 3A and 3B. In the present embodiment, the printer selected in the printer combo box 302 is described as the printer 102. Therefore, the application 201 obtains the driver capability information from the user interface module 211 in the printer driver 210 of the printer 102 via the OS print support function 202.

The CPU 103 functioning as the user interface module 211 of the printer driver 210 generates driver capability information and notifies the application 201 of the generated driver capability information. A method for generating the driver capability information by the user interface module 211 is as shown in FIG. 6.

Here, with reference to the flowchart of FIG. 6, description will be given of the driver capability information generation process executed as the processing by the printer driver 210 in a case where custom settings are saved.

The processing of S601 to S608 is loop processing, and the CPU 103 functioning as the printer driver 210 executes the processing of S602 to S607 for a processing target setting item. In S602, the CPU 103 obtains printer capability information for the processing target setting item.

In a case where the custom settings are saved, S603 to S606 are performed as the loop processing. In S604, the CPU 103 selects an unselected custom setting as the processing target from the custom setting list 700. The CPU 103 then executes the processing of S605 to S606 for the processing target custom setting, and returns to S603. If the CPU103 judged in S603 that the unselected custom setting is in the custom setting list 700 (NO in S603), the CPU 103 proceeds to S604. In the next S604, the CPU 103 selects a new processing target custom setting from among the unselected custom settings, and repeats the processing of S605 to S606.

In S605, the CPU 103 judges whether the setting item for displaying the processing target custom setting is the current processing target setting item selected in S601. If the CPU 103 judged that the setting item for displaying the processing target custom setting is the current processing target setting item (YES in S605), the CPU 103 proceeds to S606, or otherwise (NO in S605), returns to S603. In S606, the CPU 103 adds the current processing target custom setting to the driver capability information of the current processing target setting item, and returns to S603.

For example, it is assumed that the processing target setting item selected in S601 is “sheet size” and the processing target custom setting selected in S604 is the custom setting held in the row 711 of the custom setting list 700 in FIG. 7. In this case, as shown in FIG. 7, the setting item for displaying the processing target custom setting is “sheet size”. Therefore, the result of judgement by the CPU 103 in S605 is YES, and in S606, the CPU 103 adds “A4_rear tray”, which is the processing target custom setting, to the driver capability information for “sheet size”. Then, the CPU 103 returns to S603.

In the custom setting list 700 in FIG. 7, another custom setting is held in the row 712, and therefore the result of judgement by the CPU 103 in S603 is NO, and the custom setting held in the row 712 becomes the processing target in the next S604. In this case, since the setting item for displaying the processing target custom setting is “sheet type”, the result of judgement by the CPU 103 in S605 is NO. Now that all custom settings have become the processing target, the result of judgement by the CPU 103 in S603 is YES, and the CPU 103 proceeds to S607.

As a result, driver capability information for the sheet size is generated by adding the custom setting “A4 rear tray” to “A4” and “A5” as the printer capability information for the sheet size. In S607, the CPU 103 functioning as the printer driver notifies the application 201 of the driver capability information for the sheet size. In this way, the CPU 103 functioning as the printer driver 210 also functions as a notification unit to notify the application 201 of the driver capability information.

Similarly, driver capability information for other setting items is also generated by the printer driver 210. In S1101, the CPU 103 operating as the application 201 obtains the driver capability information for each setting item generated by the printer driver 210.

In S1102, the CPU 103 functioning as the application 201 displays the print instruction screen 301 after obtaining the driver capability information for the setting items required to display the print instruction screen 301.

In a case where the custom setting list 700 in FIG. 7 is saved, as described above, the driver capability information for the sheet size generated by the printer driver 210 is “A4”, “A5”, and “A4_rear tray”. The CPU 103 functioning as the application 201 adds “A4”, “A5”, and “A4_rear tray”, which are the driver capability information for the sheet size, to the pull-down menu options (setting value candidates) in the sheet size combo box 304 in the print instruction screen 301. The CPU 103 functioning as the application 201 also displays the sheet size setting of the print setting information passed from the OS print support function 202 in a selected state. The same setting is performed for the sheet type combo box 305 in the print instruction screen 301. As a result, as shown in FIG. 3B, the user can select the custom setting “A4_rear tray” from the sheet size combo box 304 in the print instruction screen 301 provided by the application 201.

In S1103, the CPU 103 judges whether the setting value of the setting item in the print instruction screen 301 is changed. If the CPU 103 judged that the setting value is changed (YES in S1103), the CPU 103 proceeds to S1104, or otherwise (NO in S1103), proceeds to S1106. In S1104, the CPU 103 judges whether the changed setting value is a setting value related to the print settings for the driver. The print instruction screen 301 provided by the application 201 also includes settings for processing print data in the application 201, rather than the print settings for the printer driver 210. For example, in the case of the print instruction screen 301 in FIGS. 3A and 3B, the sheet size combo box 304 and the sheet type combo box 305 are the print settings for the driver, and the printer combo box 302 is not the print setting for the driver.

If the CPU 103 judged that the changed setting value is the setting value of the print setting for the driver (YES in S1104), the CPU 103 proceeds to S1105, or otherwise (NO in S1104), proceeds to S1106. In S1105, the application 201 updates the print setting information to the changed setting value.

On the other hand, in S1106, the CPU 103 judges whether the print button 310 in the print instruction screen 301 is pressed. If the CPU 103 judged that the print button 310 is pressed (YES in S1106), the CPU 103 proceeds to S1107, or otherwise (NO in S1106), proceeds to S1108. In S1108, the application 201 judges whether a cancel button 311 in the print instruction screen 301 is pressed. If the CPU 103 judged that the cancel button 311 is pressed (YES in S1108), the CPU 103 ends the print instruction processing of FIG. 11, or otherwise (NO in S1108), proceeds to S1109.

In S1109, the application 201 executes other processing. For example, if the link 303 in the print instruction screen 301 is pressed by the user, the print setting processing is performed by the printer driver 210. Therefore, the flowchart of FIG. 5 is executed as the processing by the printer driver 210. As the flowchart of FIG. 5 ends, the processing returns to S1103, which is the processing by the application 201.

On the other hand, in S1107, the CPU 103 functioning as the application 201 instructs the CPU 103 functioning as the printer driver 210 to perform printing via the OS print support function 202. Then, the print instruction processing of FIG. 11 ends. Upon completion of the print instruction processing, the CPU 103 closes the print instruction screen 301 in FIGS. 3A and 3B.

### [Print Processing by Printer Driver]

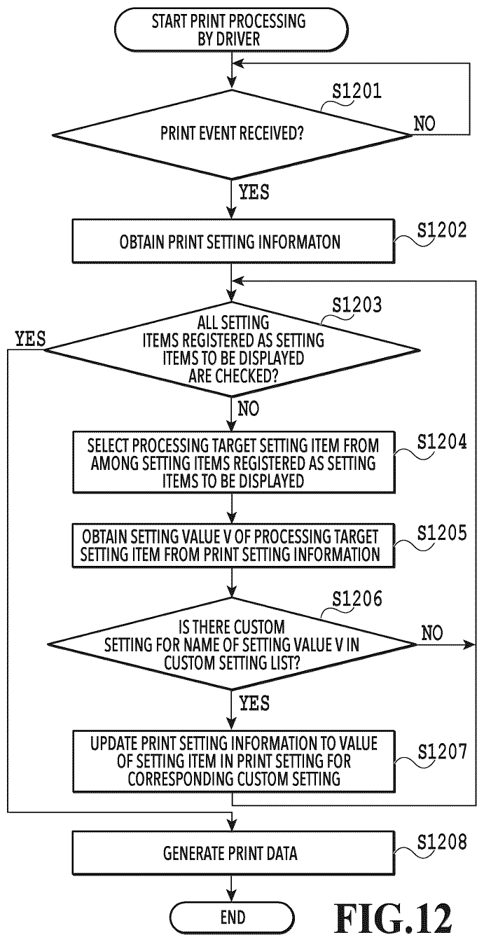

FIG. 12 is a flowchart for explaining print processing by the printer driver 210. The flowchart of FIG. 12 is executed as the processing by the printer driver 210. That is, the processing according to the flowchart of FIG. 12 is performed by expanding a program code of the printer driver 210 stored in the auxiliary storage unit 107 into the RAM 104 and executing the program code by the CPU 103.

In S1201, the CPU 103 functioning as the printer driver 210 judges whether a print instruction is received from the OS print support function 202 as processing by the user interface module 211. If the CPU 103 judged that a print event is received (YES in S1201), the CPU 103 proceeds to S1202, or otherwise (NO in S1201), repeats S1201 until a print event is received. As the application 201 issues a print instruction in S1107 of FIG. 11, the CPU 103 functioning as the printer driver receives the print event.

In S1202, the CPU 103 functioning as the printer driver 210 obtains print setting information passed from the OS print support function 202. The print setting information is information on print settings set up in the print instruction screen 301 of FIGS. 3A and 3B or the print setting screen 401 of FIGS. 4A and 4B.

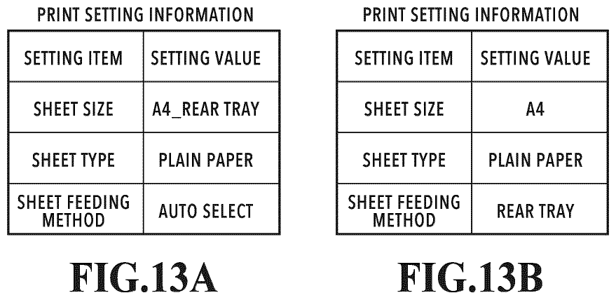

FIG. 13A is a diagram in a table format showing an example of the print setting information obtained in S1202. As shown in FIG. 3B, as the custom setting “A4_rear tray” is selected from the print instruction screen 301 and the print button 310 is pressed, print setting information as shown in FIG. 13A is generated. Accordingly, in the present embodiment, since the custom setting can be selected from the print instruction screen 301 of FIGS. 3A and 3B or the print setting screen 401 of FIGS. 4A and 4B, the print setting information may include the custom setting.

The processing of S1203 to S1207 is loop processing. In S1204, the CPU 103 selects a processing target setting item from among the setting items registered with the display destination. The setting items registered with the display destination are the setting items held in the column 702 in the custom setting list 700. If the custom setting list 700 of FIG. 7 is saved, the setting items registered with the display destination are “sheet size” and “sheet type”. The CPU 103 executes the processing of S1205 to S1207 for the processing target setting items, and returns to S1203.

In S1203, the CPU 103 judges whether all setting items registered with the display destination have been selected as the processing target. If the CPU 103 judged that there is a setting item yet to be selected as the processing target (NO in S1203), the CPU 103 proceeds again to S1204, selects a new processing target setting item from among the unselected setting items, and repeats S1205 to S1207.

In S1205, the CPU 103 obtains the setting value of the processing target setting item from the print setting information obtained in S1202.

In S1206, the CPU 103 judges whether the setting value obtained in S1205 is a value indicating a custom setting. If the CPU 103 judged that the setting value obtained in S1205 is the value indicating the custom setting (YES in S1206), the CPU 103 proceeds to S1207, or otherwise (NO in S1206), returns to S1203.

In S1207, the CPU 103 obtains, from the custom setting list 700, setting values of setting items associated with the custom setting indicated by the setting value obtained in S1205, and updates the print setting information obtained in S1202 with the obtained setting values of the setting items.

For example, it is assumed that the custom setting list 700 of FIG. 7 is saved, and the print setting information shown in FIG. 13A is obtained in S1202. After selecting “sheet size” as the processing target setting item in S1204, the CPU 103 obtains “A4_rear tray” in S1205 as the setting value of “sheet size” from the print setting information in FIG. 13A. Since “A4_rear tray” obtained in S1205 exists in the custom setting list 700 of FIG. 7, the CPU 103 judges in S1206 that “A4_rear tray” is a custom setting (YES in S1206), and proceeds to S1207. In S1207, the CPU 103 obtains setting values associated with “A4 rear tray” from the custom setting list 700 of FIG. 7. That is, “A4” is obtained as the setting value of “sheet size” and “rear tray” is obtained as the setting value of “sheet feeding method”. Then, the CPU 103 changes the setting value of “sheet size” in the print setting information of FIG. 13A from “A4_rear tray” to “A4” thus obtained, and changes the setting value of “sheet feeding method” from “auto select” to “rear tray” thus obtained. As a result, the print setting information is updated as shown in FIG. 13B.

On the other hand, if the CPU 103 judged that all setting items registered with the display destination have been selected as the processing target (YES in S1203), the CPU 103 proceeds to S1208. In S1208, the CPU 103 generates print data. The processing after the print data generation is as described in the print system configuration described above.

### [Editing Saved Custom Settings]

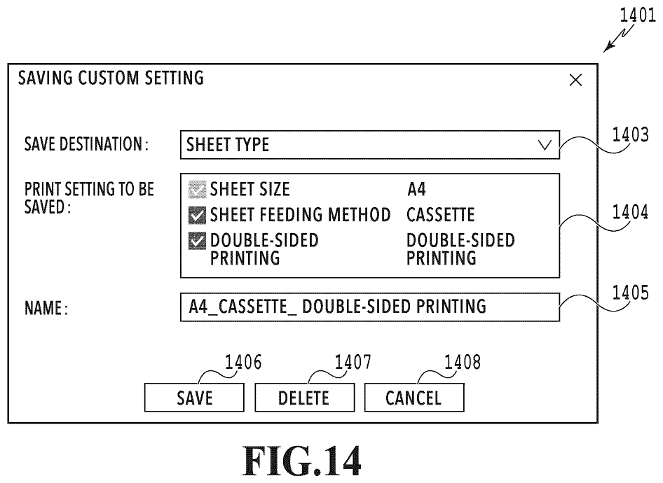

FIG. 14 is a diagram showing an example of a custom setting edit screen. The user can edit the contents of the saved custom settings from a custom setting edit screen 1401. For example, in a case where at least one custom setting is saved, the custom setting is displayed as a candidate in a pull-down menu 415 of a sheet size combo box 402 in the print setting screen 401 of the printer driver 210, as shown in FIG. 4B. Upon detection of a custom setting, the CPU 103 functioning as the user interface module 211 of the printer driver 210 displays the custom setting edit screen 1401 for editing the selected custom setting. The custom setting edit screen 1401 may be displayed using a button or the like for displaying the custom setting edit screen (not shown).

If a save destination combo box 1403 in the custom setting edit screen 1401 is operated, the printer driver 210 operates in the same way as in the case of the save destination combo box 903 in FIG. 9. A print setting list box 1404 is the same as the print setting list box 904 in FIG. 9, and a name edit box 1405 is the same as the name edit box 905.

As the user presses a save button 1406, the CPU 103 can update the saved custom setting with the contents shown in the custom setting edit screen 1401. As the user presses a delete button 1407, the CPU 103 deletes the selected custom setting. The deleted custom setting is deleted from the custom setting list 700 and is no longer added to the driver capability information. As the user presses a cancel button 1408, the CPU 103 closes the custom setting edit screen 1401 without saving the edit made in the custom setting edit screen 1401.

The custom setting edit screen 1401 of FIG. 14 is an example of a screen that does not allow editing of the setting values of the print settings to be saved. However, a custom setting edit screen that allows editing of the setting values of the print settings may be displayed. For example, a control for editing the setting values of the print settings to be saved may be provided in the custom setting edit screen 1401, so that the setting values of the print settings to be saved can be edited.

As described above, according to the present embodiment, the user can set up the printer driver 210 in a way that cannot be done from the application 201 or the print instruction screen 301 of the OS without starting the print setting screen 401 of the printer driver 210.

The custom settings have been described as being saved as the user presses the Yes button 906 in the custom setting save screen 901. For example, the custom settings may also be pre-saved. For example, custom settings such as those included in the custom setting list 700 of FIG. 7 may be included in the printer driver 210. Then, as the printer driver 210 is installed in the PC 101, the custom setting list 700 of FIG. 7 that is pre-included in the printer driver 210 may be saved in the auxiliary storage unit 107.

Improved usability during print setting is required, and the present disclosure makes it possible to improve the usability during print setting.

### Embodiment 2

The printer driver 210 has a function to save and use frequently used settings as favorite settings. The favorite setting is associated with print setting information including one or more print settings frequently used by the user. As the user selects a favorite setting, print settings are made based on the print setting information associated with the selected favorite setting. In the present embodiment, description will be given of a method for adding a saved favorite setting to driver capability information of a certain setting item so that the favorite setting can be selected from the application 201.

### [Favorite Registration Function]

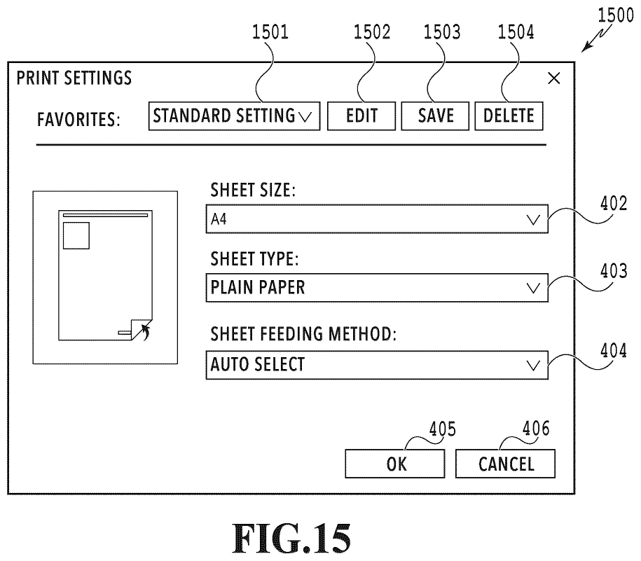

FIG. 15 is a diagram showing an example of a print setting screen of the printer driver 210 having a favorite setting function.

A print setting screen 1500 of FIG. 15 is different from the print setting screen 401 of FIGS. 4A and 4B in further including a favorite combo box 1501, an edit button 1502, a save button 1503, and a delete button 1504. The favorite combo box 1501 is a combo box for the user to select a registered favorite setting. The edit button 1502 is a button for starting a screen for editing the favorite setting selected in the favorite combo box 1501. The save button 1503 is a button for starting a screen for registering the favorite setting. The delete button 1504 is a button for deleting the favorite setting selected in the favorite combo box 1501.

### [Favorite Registration]

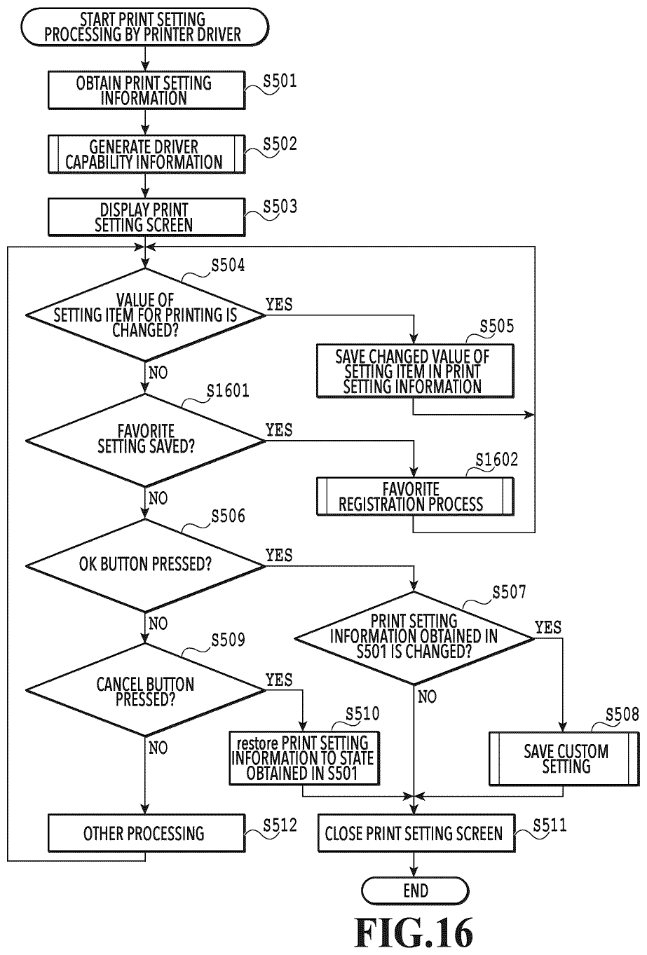

FIG. 16 is a flowchart for explaining print setting processing by the printer driver 210 having the favorite setting function. The flowchart of FIG. 16 is executed as the processing by the printer driver 210. That is, the processing according to the flowchart of FIG. 16 is performed by expanding a program code of the printer driver 210 stored in the auxiliary storage unit 107 into the RAM 104 and executing the program code by the CPU 103.

FIG. 16 is a flowchart of the present embodiment corresponding to the flowchart of FIG. 5. Therefore, the same steps as those in FIG. 5 are denoted by the same numbers in FIG. 16 as those in FIG. 5. S501 to S505 and S506 to S507 are the same steps as in FIG. 5, and thus description thereof will be omitted.

If the CPU 103 judged in S504 that the setting value of the setting item is changed in the print setting screen 1500 (YES in S504), the CPU 103 proceeds to S505, or otherwise (NO in S504), proceeds to S1601 in the present embodiment.

In S1601, the CPU 103 functioning as the printer driver 210 judges whether the save button 1503 for favorite settings is pressed by the user in the print setting screen 1500. If the CPU 103 judged that the save button 1503 is pressed (YES in S1601), the CPU 103 proceeds to S1602, or otherwise (NO in S1601), proceeds to S506.

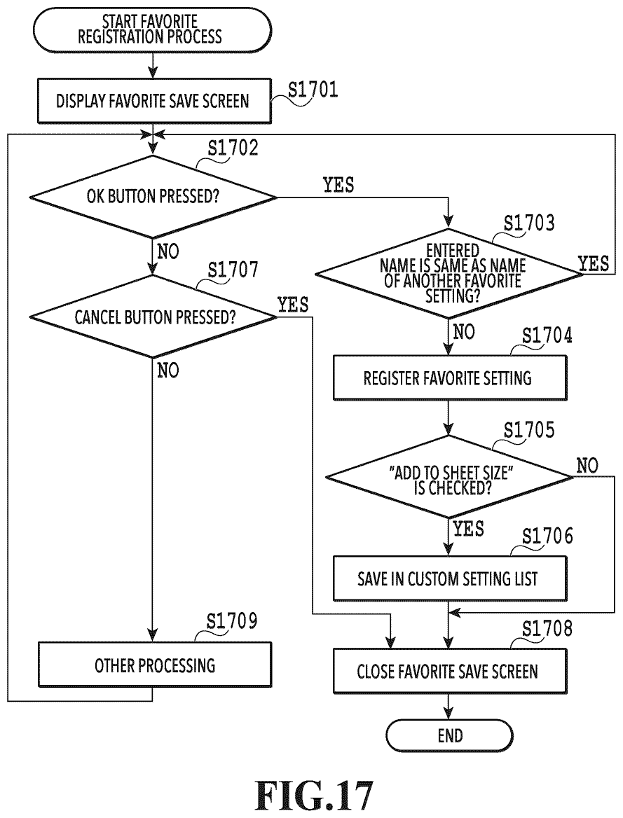

FIG. 17 is a flowchart for explaining details of a favorite registration process executed in S1602. The flowchart of FIG. 17 is executed as the processing by the printer driver 210. That is, the processing according to the flowchart of FIG. 17 is performed by expanding a program code of the printer driver 210 stored in the auxiliary storage unit 107 into the RAM 104 and executing the program code by the CPU 103.

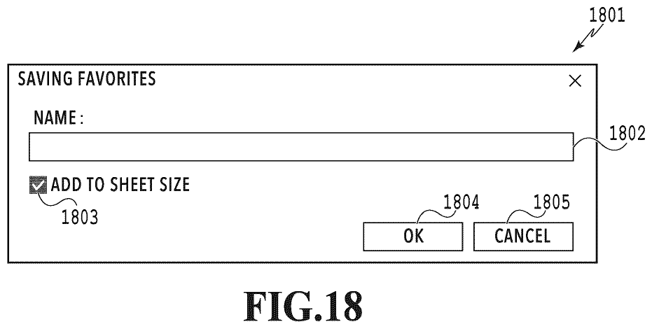

In S1701, the CPU 103 functioning as the printer driver 210 displays a favorite save screen 1801 (see FIG. 18) and proceeds to S1702.

FIG. 18 is a diagram showing an example of the favorite save screen 1801. As the user enters an arbitrary character string in a name edit box 1802 as the name of a favorite to be registered this time, an OK button 1804 is enabled to be pressed. The OK button 1804 is detected by the user interface module 211.

In S1702, the CPU 103 judges whether the OK button 1804 is pressed by the user in the favorite save screen 1801. If the CPU 103 judged that the OK button 1804 is pressed (YES in S1702), the CPU 103 proceeds to S1703, or otherwise (NO in S1702), proceeds to S1707.

In S1703, the CPU 103 judges whether the name entered by the user in the name edit box 1802 is the same as the name of the registered favorite setting. If the CPU 103 judged that the entered name is the same as the name of the registered favorite setting (YES in S1703), the CPU 103 returns to S1702 and prompts the user to change the name, or otherwise (NO in S1703), proceeds to S1704.

In S1704, the CPU 103 determines that the name entered in the name edit box 1802 is the name of the favorite setting to be registered this time. The CPU 103 then registers the favorite setting by saving the print setting information indicating the print setting currently selected in the print setting screen 1500 in association with the determined name of the favorite setting. The favorite setting will be described as being registered in a favorite setting list (not shown). The favorite setting list is a list in which the name of the favorite setting is associated with the print setting information.

In S1705, the CPU 103 judges whether a check box 1803 for adding to the sheet size in the favorite save screen 1801 is checked. If the CPU 103 judged that the check box 1803 is checked (YES in S1705), the CPU 103 proceeds to S1706, or otherwise (NO in S1705), skips S1706 and proceeds to S1708.

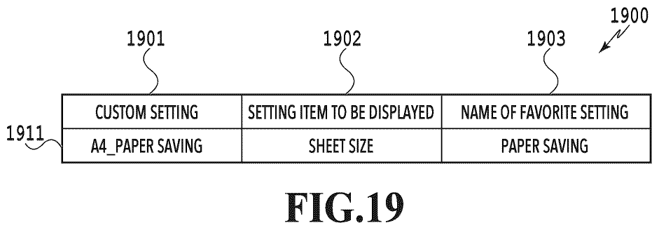

In S1706, the CPU 103 creates a name for the custom setting. The CPU 103 then saves the created name of the custom setting in a custom setting list 1900 of the present embodiment (see FIG. 19), in association with the name of the favorite setting saved in S1704. After saving the custom setting in the custom setting list 1900, the CPU 103 proceeds to S1708.

The CPU 103 creates, as the name of the custom setting, a character string by concatenating, for example, a character string indicating the setting value set for “sheet size”, a delimiter, and a character string indicating the name of the favorite setting registered in S1704.

FIG. 19 is a diagram showing an example of the custom setting list of the present embodiment. The custom setting list 1900 of FIG. 19 has a row for each custom setting. In each row, a column 1901 holds a name representing the custom setting, a column 1902 holds a setting item for displaying the custom setting, and a column 1903 holds the name of the favorite setting associated with the custom setting. In the present embodiment, the setting item for displaying the custom setting associated with the favorite setting is “sheet size” as an example. Therefore, as shown in FIG. 19, the column 1902 holds “sheet size”.

The column 1903 also holds “paper saving”, which is the name of the favorite setting entered in the name edit box 1802 and registered in S1704.

In S1707, the CPU 103 judges whether a cancel button 1805 is pressed by the user in the favorite save screen 1801. If the CPU 103 judged that the cancel button 1805 is pressed (YES in S1707), the CPU 103 proceeds to S1708, or otherwise (NO in S1707), proceeds to S1709.

In S1708, the CPU 103 closes the favorite save screen 1801 and ends the favorite registration process shown in FIG. 17.

In S1709, upon detection of an operation other than pressing the OK button 1804 or the cancel button 1805, the CPU 103 executes other processing and returns to S1702.

### [Setting Saved Favorites From Application]

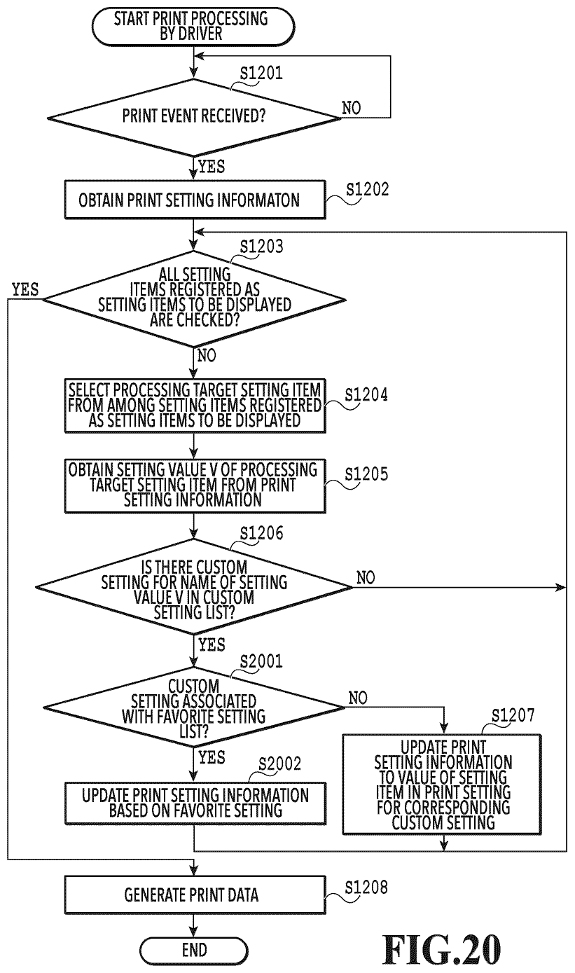

FIG. 20 is a flowchart for explaining print processing by the printer driver 210. The flowchart of FIG. 20 is performed as the processing by the printer driver 210. That is, the processing according to the flowchart of FIG. 20 is performed by expanding a program code of the printer driver 210 stored in the auxiliary storage unit 107 into the RAM 104 and executing the program code by the CPU 103.

FIG. 20 is a flowchart of the present embodiment corresponding to the flowchart of FIG. 12. Therefore, the same steps as those in FIG. 12 are denoted by the same numbers in FIG. 20 as those in FIG. 12. S1201 to S1208 are the same steps as in FIG. 12, and thus description thereof will be omitted.

In S1206, the CPU 103 judges whether the setting value of the processing target setting item in the print setting information is a value indicating a custom setting held in the custom setting list 1900. If the CPU 103 judged that the setting value obtained in S1205 is the value indicating the custom setting (YES in S1206), the CPU 103 proceeds to S2001 in the present embodiment, or otherwise (NO in S1206), returns to S1203.

In S2001, the CPU 103 judges whether the custom setting indicated by the setting value obtained in S1205 is associated with a favorite setting in the custom setting list 1900. If the CPU 103 judged that the custom setting is associated with the favorite setting (YES in S2001), the CPU 103 proceeds to S2002, or otherwise (NO in S2001), proceeds to S1207.

It is assumed that the custom setting list 1900 of FIG. 19 is saved, and the setting value of the processing target setting item obtained in S1205 is “A4_paper saving”. In this case, as shown in FIG. 19, the custom setting “A4_paper saving” is associated with the favorite setting “paper saving”. Therefore, the result of judgement in S2001 is YES, and the processing proceeds to S2002.

In S2002, the CPU 103 obtains the name of the favorite setting associated with the custom setting indicated by the setting value obtained in S1205. The CPU 103 obtains print setting information associated with the obtained name of the favorite setting in the favorite setting list (not shown), and reflects the obtained print setting information in the current print setting information obtained in S1202.

As in Embodiment 1, upon completion of checking for all setting items for which custom settings are displayed, print data is generated based on the print setting information.

The processing in which the application 201 instructs the printer driver 210 to print is the same as in Embodiment 1. For example, in the custom setting list 1900 of FIG. 19, a row 1911 holds information on the custom setting named “A4_paper saving”. The column 1902 of the row 1911 holds “sheet size” as the setting item for displaying the custom setting. Therefore, the custom setting “A4_paper saving” is added to the driver capability information for the sheet size. Accordingly, in the present embodiment, “A4_paper saving” can be selected from the sheet size combo box 304 in the print instruction screen 301 provided by the application 201. As the custom setting of “A4_paper saving” is selected from the print instruction screen 301, the print setting is made in the same way as in selection of the favorite setting “paper saving”.

As described above, according to the present embodiment, the user can select a favorite setting without starting the print setting screen 401 of the printer driver 210 every time printing is performed.

The various controls described above as being performed by the CPU 103 may be performed by a single piece of hardware, or the entire apparatus may be controlled by a plurality of pieces of hardware (for example, a plurality of processors or circuits) sharing the processing.

The technology of the present disclosure has been described in detail based on the preferred embodiments, but the technology of the present disclosure is not limited to these specific embodiments, and also includes various embodiments without departing from the gist of the technology of the present disclosure. The embodiments described above each merely shows one embodiment of the technology of the present disclosure, and may be combined as appropriate.

The embodiments have been described above using the example of applying the technology of the present disclosure to the PC 101. However, the technology of the present disclosure is not limited to this example and can be applied to any apparatus capable of generating print data and issuing a print instruction to a printer. In other words, the technology of the present disclosure is applicable to a personal computer, PDA, mobile phone terminal, portable image viewer, and a printer device equipped with a display. The technology of the present disclosure is also applicable to a digital photo frame, music player, game machine, e-book reader, smartphone, tablet, and the like.

### Other Embodiments

In the above embodiments, the description has been given of the method for including custom settings in the print setting screen of the application in the print processing of displayed content. The method of the embodiments described above is also applicable to contents processing other than the print processing of contents. Specifically, in a case where a program other than the application performs processing of contents, the program that performs the processing notifies the application of candidates including custom settings. Then, if it is set via the application to perform the processing of contents with custom settings, software for performing the processing may perform the contents processing by reflecting the custom settings.

The present disclosure can also be implemented by executing the following processing. Specifically, software (program) for implementing the functions of the above embodiments is supplied to a system or apparatus via a network or various storage media, and a computer (or CPU, MPU, or the like) of the system or apparatus reads and executes a program code. In this case, the program and a storage medium storing the program constitute the technology of the present disclosure.

Embodiment(s) of the present disclosure can also be realized by a computer of a system or apparatus that reads out and executes computer executable instructions (for example, one or more programs) recorded on a storage medium (which may also be referred to more fully as a ‘non-transitory computer-readable storage medium’) to perform the functions of one or more of the above-described embodiment(s) and/or that includes one or more circuits (for example, application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (for example, central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-150053, filed Aug. 30, 2024, which is hereby incorporated by reference herein in its entirety.

What is claimed is:

1. A non-transitory computer readable storage medium storing a program which causes a computer to function as:
a notification unit configured to notify application software capable of receiving an instruction to print displayed contents of information on a plurality of candidates including a specific candidate as a candidate that can be set for a first setting item related to printing;
an obtaining unit configured to obtain a print instruction including content set for the first setting item from the application software; and
a control unit configured to control so that, as the obtaining unit obtains a print instruction indicating that a setting corresponding to the specific candidate is selected for the first setting item, printing is performed by setting values for the first setting item and a second setting item related to printing different from the first setting item to values corresponding to the specific candidate.

2. The program according to claim 1, wherein
the specific candidate is a candidate customized by a user.

3. The program according to claim 2, wherein
the specific candidate is a candidate customized by a user operation by specifying values of both the first setting item and the second setting item in a setting screen provided by the program.

4. The program according to claim 2, wherein
the first setting item is a setting item for which a user can select a value from a plurality of candidates in a print setting screen provided by the application software, and
the second setting item is a setting item for which a user cannot select a value in the print setting screen provided by the application software.

5. The program according to claim 1, wherein
the first setting item is a sheet size.

6. The program according to claim 1, wherein
the second setting item is a sheet feeding method.

7. The program according to claim 1, wherein
the program is driver software for controlling a printing apparatus.

8. The program according to claim 1, wherein
a setting changed by the user via a setting screen provided by the program is saved as the specific candidate.

9. The program according to claim 1, wherein the computer further functions as:
a generation unit configured to generate a name of the specific candidate.

10. The program according to claim 9, wherein
the generation unit generates a name indicating both a value specified for the first setting item and a value specified for the second setting item.

11. The program according to claim 1, wherein
there are a plurality of setting items that can be the first setting item, and
the first setting item is a setting item selected by the user from the plurality of setting items.

12. The program according to claim 1, wherein the computer further functions as:
a registration unit configured to register a value of a setting item selected by a user as a favorite setting, wherein
the control unit controls so that printing is performed based on the value of the setting item saved as the favorite setting in a case where the obtaining unit obtains a print instruction indicating that the specific candidate is set for the first setting item and the favorite setting is associated as a setting corresponding to the specific candidate.

13. The program according to claim 1, wherein the computer further functions as:
a display control unit configured to display a setting screen provided by the program, wherein
the setting screen is configured to enable editing of content of the specific candidate or deletion of the specific candidate from the setting screen.

14. The program according to claim 1, wherein
the specific candidate is included in advance in the program.

15. The program according to claim 1, wherein the computer further functions as:
a display control unit configured to display a save screen for saving the specific candidate if a user changes a default value in a setting screen provided by the program; and
a saving unit configured to save the specific candidate by setting a setting item selected by the user in the save screen as the first setting item, and a setting item whose value is changed from the default value by the user in the setting screen as the second setting item.

16. A non-transitory computer readable storage medium storing a program which causes a computer to function as:
a notification unit configured to notify application software capable of receiving an instruction to perform processing of displayed contents of information on a plurality of candidates including a specific candidate that can be set for a first setting item related to the processing;
an obtaining unit configured to obtain an instruction of the processing including content set for the first setting item from the application software; and
a control unit configured to control so that, as the obtaining unit obtains an instruction indicating that a setting corresponding to the specific candidate is selected for the first setting item, the processing is performed by setting values for the first setting item and a second setting item related to the processing different from the first setting item to values corresponding to the specific candidate.

17. An information processing apparatus, comprising:
at least one memory and at least one processor which function as:
a notification unit configured to notify application software capable of receiving an instruction to print displayed contents of information on a plurality of candidates including a specific candidate as a candidate that can be set for a first setting item related to printing;
an obtaining unit configured to obtain a print instruction including content set for the first setting item from the application software; and
a control unit configured to control so that, as the obtaining unit obtains a print instruction indicating that a setting corresponding to the specific candidate is selected for the first setting item, printing is performed by setting values for the first setting item and a second setting item related to printing different from the first setting item to values corresponding to the specific candidate.

18. An information processing method comprising:
notifying application software capable of receiving an instruction to print displayed contents of information on a plurality of candidates including a specific candidate as a candidate that can be set for a first setting item related to printing;
obtaining a print instruction including content set for the first setting item from the application software; and
controlling so that, as a print instruction indicating that a setting corresponding to the specific candidate is selected for the first setting item is obtained, printing is performed by setting values for the first setting item and a second setting item related to printing different from the first setting item to values corresponding to the specific candidate.

19. An information processing apparatus capable of operating driver software for controlling a printing apparatus and application software capable of receiving an instruction to print displayed contents,
the driver software configured to execute processing of:
notifying the application software of information on a plurality of candidates including a specific candidate as a candidate that can be set for a first setting item related to printing;
obtaining a print instruction including content set for the first setting item from the application software; and
controlling so that, as a print instruction indicating that a setting corresponding to the specific candidate is selected for the first setting item is obtained, printing is performed by setting values for the first setting item and a second setting item related to printing different from the first setting item to values corresponding to the specific candidate,
the application software configured to execute processing of:
receiving a user's operation to select one of the plurality of candidate information notified by the driver software for the first setting item; and
upon receipt of a print instruction, notifying the driver software of information indicating the selected candidate for the first setting item.
